(19) United States
(12) Patent Application Publication
(10) Pub. No.: US 2013/0111636 A1
(43) Pub. Date: May 2, 2013

(54) NON-LINEAR INTERACTION IMAGING AND SPECTROSCOPY

(71) Applicant: Stephen Jesse, Knoxville, TN (US)

(72) Inventor: Stephen Jesse, Knoxville, TN (US)

(73) Assignee: UT-BATTELLE, LLC, Oak Ridge, TN (US)

(21) Appl. No.: 13/284,155

(22) Filed: Oct. 28, 2011

(51) Int. Cl. G01Q 60/24; G01Q 70/08

(52) U.S. Cl. 850/33; 850/56

(57) ABSTRACT

This system includes non-linear interaction imaging and spectroscopy (“NIIS”) for scanning probe microscopy. Scanning probe microscopy operates with an oscillating tip and cantilever to monitor characteristics of the oscillation and NIIS measures both the linear and non-linear components of the interactions between the probe tip and the surface.

### STATEMENT REGARDING FEDERALLY SPONSORED RESEARCH

This invention was made with government support under Contract No. DE-AC05-000R22725 awarded by the U.S. Department of Energy. The government has certain rights in the invention.

### BACKGROUND

Atomic force microscopy (“AFM”) may operate in a mode characterized by oscillating the AFM tip and cantilever. This may be referred to as tapping mode, amplitude modulated mode, frequency modulated mode, non-contact mode, tuning fork mode, or dual-frequency mode. Characteristics of the oscillation may be monitored using lock-in amplifiers. In these oscillating tip modes, the tip motion may be driven by a sinusoidal waveform of known amplitude and phase. The signal of the time-varying position of the tip may be sent to a lock-in amplifier which returns the relative amplitude and phase of the response to the excitation. The analysis may rely on an underlying assumption that the response is a perfect sinusoid, and is perfectly linear with respect to the excitation.

### BRIEF DESCRIPTION OF THE DRAWINGS

The system and method may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 is an example of scanning probe microscopy;

FIG. 2 illustrates an exemplary interaction;

FIG. 3 illustrates an exemplary nonlinear interaction;

FIG. 4 illustrates another exemplary nonlinear interaction;

FIG. 5 is an exemplary NIIS process;

FIG. 6 illustrates a simulation of the equation of motion;

FIG. 7 illustrates a modeled response of a cantilever in close proximity to a Leonard-Jones potential;

FIG. 8 is a plot of the excitation (chirp function) and

FIG. 9 is a plot of the response waveform to the plot from FIG. 8;

FIG. 10 is a Fourier transform of the response from FIG. 9 over the band of excitation frequencies;

FIG. 11 is a plot of the derived force-distance curve for the case of a Leonard-Jones potential; and

FIG. 12 is a plot of a potential well with non-linearities.

### DETAILED DESCRIPTION

Although the analysis of tapping mode oscillation may assume that the sinusoidal waveform of is a perfect sinusoid and is perfectly linear with respect to the excitation, there may exist non-linearities of the interaction of the tip with the surface. An analysis of these non-linearities may provide additional information. This system includes non-linear interaction imaging and spectroscopy (“NIIS”) for scanning probe microscopy. NIIS may measure both the linear and non-linear components of the interactions between the probe tip and the surface.

Scanning probe microscopy may include atomic force microscopy (“AFM”), scanning tunneling microscopy (“STM”), and near-field scanning optical microscopy (“NSOM”). The NIIS analysis described below may apply to any form of scanning probe microscopy, but the description below will relate to AFM for simplicity. AFM may operate in a mode characterized by oscillating an AFM tip and cantilever and may be referred to as tapping mode, amplitude modulated mode, frequency modulated mode, non-contact mode, tuning fork mode, or dual-frequency mode. The characteristics of the oscillation are monitored and analyzed as discussed below. These oscillating tip modes will be referred to as tapping mode for simplicity.

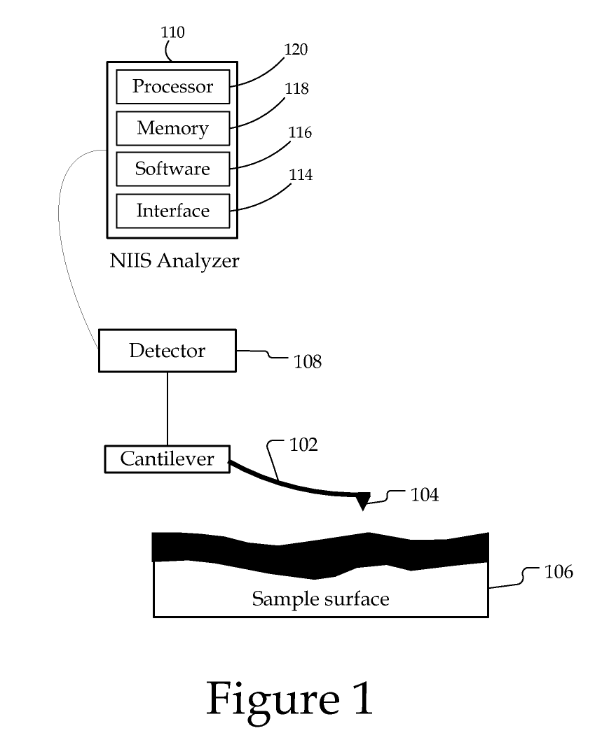

FIG. 1 is an example of scanning probe microscopy. A cantilever 102 with a probe 104 may probe a sample surface 106. The tip 104 may also be referred to as a tip or a probe tip. The probe 104 scans the surface 106 and a detector monitors and records information about the surface 106. The information may be analyzed by a non-linear interaction imaging and spectroscopy (“NIIS”) analyzer 110.

The probe 104 may have a very sharp tip with a width on the order of 1-100 micrometers with a 1-100 nanometer radius of curvature. These probe 104 sizes are merely exemplary and the probe 104 may be of a different size. The cantilever 102 is flexible such that the probe 104 may follow the sample surface 106 as it is moved over a certain area. Forces of interaction between the surface 106 and the probe 104 cause the cantilever 102 to move. The movements of the cantilever 102 are detected by the detector 108, which may be referred to as a sensor that senses movement of the cantilever 102. Different probes 104 may be used to analyze different types of interactions with surface 106 and to analyze different surfaces.

In one embodiment, the probe 104 may be maintained at a constant force by moving the cantilever 102 up and down as it scans. Alternatively, the probe 104 may be driven up and down by an oscillator and the bottom-most point of each probe cycle may be in the attractive region of the force-distance curve. Alternatively, the bottom-most point may be in the repulsive region of the force-distance curve. The detector 108 measures changes in the oscillation amplitude and the phase to analyze the interaction of the probe 104 with the surface 106.

The detector 108 measures the movement of the cantilever 102. The detector 108 may utilize laser deflection or interferometry for detection. For example, the detector 108 may comprise a laser reflected from the cantilever and photodiodes that detect movement of the reflected laser. The detector 108 measures not only the linear components of the probe 104 and surface 106 interaction, but also the nonlinear interactions. For example, short range forces may be generated when the probe 104 is closest to the surface 106, and the detector 108 may measure the interaction within this nonlinear regime.

The NIIS analyzer 110 receives measurements from the detector 108 for analysis. In one embodiment, the detector 108 and the NIIS analyzer 110 may be a single component. Alternatively, as described below, the detector 108 is the sensor that receives measurements from the cantilever 102 and the NIIS analyzer 110 analyzes the measurements from the detector 108. The NIIS analyzer 110 may rapidly determine and discern both the linear and nonlinear components of probe-surface interaction and extract both the metrics of probe motion, such as amplitude, resonance, and dissipation, as well as the force-distance curves for arbitrary probe-surface interactions. The NIIS analysis may be a general protocol applicable to the measurement and analysis of any oscillator.

The analysis of nonlinear information by the NIIS analyzer 110 may eliminate a need to prefilter the data. For example, lock-in amplifiers may ignore any information about the tip trajectory that does not match a linear (sinusoidal) behavior. The use of lock-ins may be a convenience to significantly reduce the complexity of the acquisition process, and consequently the complexity of the information acquired. However, the filtering may lose the true nature of tip-surface interaction. The NIIS analyzer 110 does not need to exclude (filter) any information as a matter of convenience.

The NIIS analyzer 110 may be a computing device for analyzing data from the detector 108 regarding an interaction between the probe 104 and the surface 106. The NIIS analyzer 110 may include a processor 120, a memory 118, software 116 and an interface 114. The NIIS analyzer 110 may be a separate component from the detector 108, or it may be combined as a single component or hardware device.

The interface 114 may communicate with the detector 108 or may be an interface for user interaction with the NIIS analyzer 110. The interface 114 may include a user interface configured to allow a user and/or administrator to interact with any of the components of the NIIS analyzer 110. For example, a user may be able to update or review the interaction data from the detector 108, as well as modify the methodology used by the NIIS analyzer 110 for analyzing the detected data.

The processor 120 in the NIIS analyzer 110 may include a central processing unit (CPU), a graphics processing unit (GPU), a digital signal processor (DSP) or other type of processing device. The processor 120 may be a component in any one of a variety of systems. For example, the processor 120 may be part of a standard personal computer or a workstation. The processor 120 may be one or more general processors, digital signal processors, application specific integrated circuits, field programmable gate arrays, servers, networks, digital circuits, analog circuits, combinations thereof, or other now known or later developed devices for analyzing and processing data. The processor 120 may operate in conjunction with a software program, such as code generated manually (i.e., programmed).

The processor 120 may be coupled with the memory 118, or the memory 118 may be a separate component. The software 116 may be stored in the memory 118. The memory 118 may include, but is not limited to, computer readable storage media such as various types of volatile and non-volatile storage media, including random access memory, read-only memory, programmable read-only memory, electrically programmable read-only memory, electrically erasable read-only memory, flash memory, magnetic tape or disk, optical media and the like. The memory 118 may include a random access memory for the processor 120. Alternatively, the memory 118 may be separate from the processor 120, such as a cache memory of a processor, the system memory, or other memory. The memory 118 may be an external storage device or database for storing recorded ad or user data. Examples include a hard drive, compact disc (“CD”), digital video disc (“DVD”), memory card, memory stick, floppy disc, universal serial bus (“USB”) memory device, or any other device operative to store ad or user data. The memory 118 is operable to store instructions executable by the processor 120.

The functions, acts or tasks illustrated in the figures or described herein may be performed by the programmed processor executing the instructions stored in the memory 118. The functions, acts or tasks are independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like. The processor 120 is configured to execute the software 116.

The interface 114 may be a user input device or a display. The interface 114 may include a keyboard, keypad or a cursor control device, such as a mouse, or a joystick, touch screen display, remote control or any other device operative to allow a user to interact with the NIIS analyzer 110. The interface 114 may include a display coupled with the processor 120 and configured to display an output from the processor 120. The display may be a liquid crystal display (LCD), an organic light emitting diode (OLED), a flat panel display, a solid state display, a cathode ray tube (CRT), a projector, a printer or other now known or later developed display device for outputting determined information. The display may act as an interface for the user to see the functioning of the processor 120 or the results of the data analysis. In particular, the interface 114 may allow a user to interact with the NIIS analyzer 110 to view results from the analysis of the interaction or control the detection of the interaction between the probe 104 and the surface 106.

The present disclosure contemplates a computer-readable medium that includes instructions or receives and executes instructions responsive to a propagated signal, so that a device connected to a network can communicate voice, video, audio, images or any other data over a network. The interface 114 may be used to provide the instructions over the network via a communication port. The communication port may be created in software or may be a physical connection in hardware. The communication port may be configured to connect with a network, external media, display, or any other components in system 100, or combinations thereof. The connection with the network may be a physical connection, such as a wired Ethernet connection or may be established wirelessly as discussed below. Likewise, the connections with other components of the system 100 may be physical connections or may be established wirelessly.

Any of the components in the system 100 may be coupled with one another through a network, including but not limited to the network 104. For example, the NIIS analyzer 110 may be coupled with the ad/publisher server 106 through a network. Accordingly, any of the components in the system 100 may include communication ports configured to connect with a network.

The network or networks that may connect any of the components in the system 100 to enable communication of data between the devices may include wired networks, wireless networks, or combinations thereof. The wireless network may be a cellular telephone network, a network operating according to a standardized protocol such as IEEE 802.11, 802.16, 802.20, published by the Institute of Electrical and Electronics Engineers, Inc., or WiMax network. Further, the network(s) may be a public network, such as the Internet, a private network, such as an intranet, or combinations thereof, and may utilize a variety of networking protocols now available or later developed including, but not limited to TCP/IP based networking protocols. The network(s) may include one or more of a local area network (LAN), a wide area network (WAN), a direct connection such as through a Universal Serial Bus (USB) port, and the like, and may include the set of interconnected networks that make up the Internet. The network(s) may include any communication method or employ any form of machine-readable media for communicating information from one device to another. As discussed, the detected data from the detector 108 may be transmitted over a network, such as the network 104, as well as the analysis of that data from the NIIS analyzer 110.

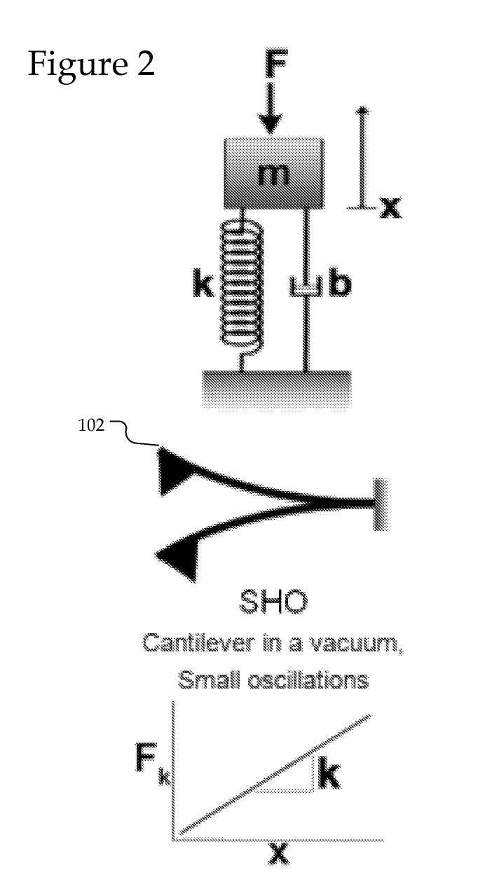

FIG. 2 illustrates an exemplary interaction. The interaction between of the cantilever is shown without a direct interaction with the surface. In other words, the interaction takes place in a vacuum. As shown in FIG. 2, F is the force applied to the mass m. The distance that the mass m moves is x and k is the spring constant. The graph in FIG. 2 shows that a plot of x vs. F in the vacuum environment is a one-to-one ratio. In other words, the interaction is linear in FIG. 2.

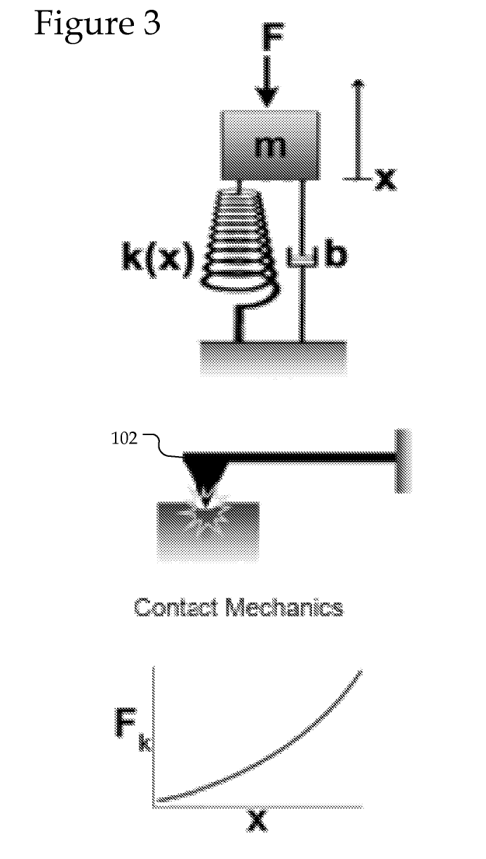

FIG. 3 illustrates an exemplary nonlinear interaction. In FIG. 3, the tip of the cantilever may contact with the surface and this contact results in a nonlinear interaction as shown in the plot of x vs. F.

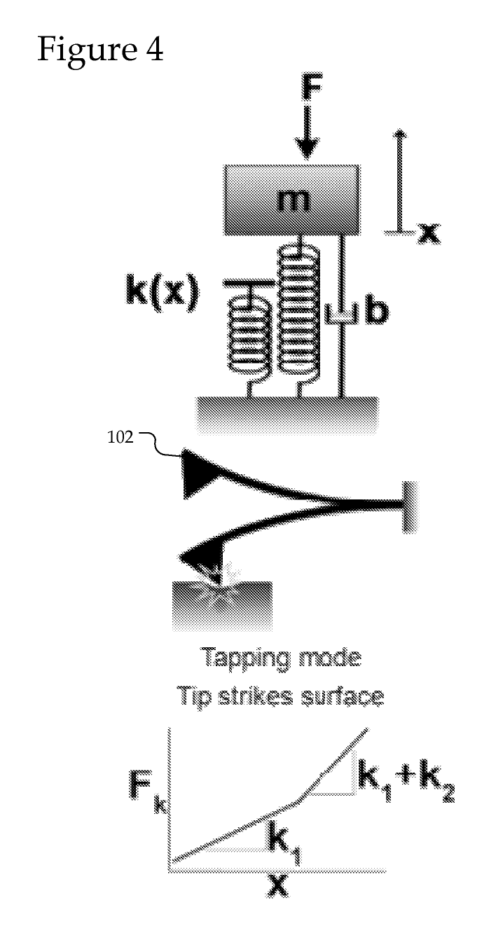

FIG. 4 illustrates another exemplary nonlinear interaction. FIG. 4 illustrates tapping mode when the tip strikes the surface. The tip or probe striking the surface is a nonlinear interaction as shown in the plot in which the spring constant is k₁ initially and k₁+k₂ for increased force F.

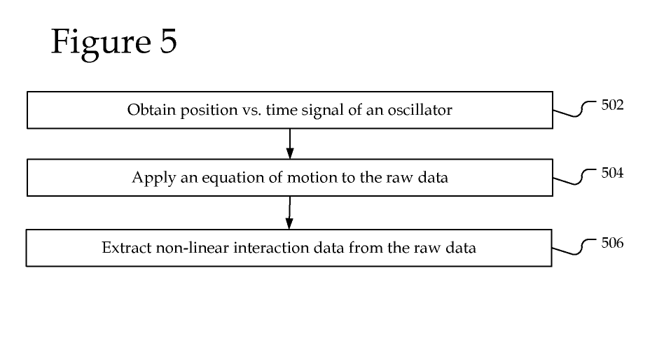

FIG. 5 is an exemplary NIIS process. In block 502, a position vs. time signal is obtained for an oscillator. In one example, the oscillator is a cantilever from scanning probe microscopy, such as an atomic force microscope. In one embodiment, FIGS. 3 and 4 illustrate exemplary position vs. time signals that are nonlinear. This signal may be used for application of an equation of motion as in block 504. Non-linear interaction data is extracted and analyzed from the raw data in block 506. The NIIS analyzer 110 may apply the equation of motion and extract the non-linear interaction data for analysis.

An exemplary equation of motion in block 504 is for a damped oscillator within an arbitrarily shaped potential well:

m·\ddot{x}(t)+b·\dot{x}(t)+[k+p(x(t))]·x=h(t) (1)

where x is position, m is mass, b is damping, k is the linear spring stiffness, p(x(t)) is the nonlinear component of spring stiffness, and h is the excitation signal. This equation is merely exemplary and other equations of motion may be substituted in block 504 including more detailed or complicated equations describing different types of motion. Other examples include equations for coupled modes, more complicated beam shapes, compensating factors that take into account the behavior of the photo-detector or other problems inherent to measurement. The integral version of equation (1) may be used to avoid the noise amplification inherent to successive differentiation of data. A similar approach may also be performed on the Fourier or Laplace transformed version of equation (1).

The extraction of non-linear data in block 506 may be accomplished without solving the equation of motion. The method for extracting non-linear data by the NIIS analyzer 110 is described below. For AFM, the cantilever has already solved the equation because knowledge of the excitation signal and the measurement of tip deflection as a function of time are the solutions to this equation and we can measure those values. The coefficients (m, b, k) and the shape of p(x) may be used for the analysis by the NIIS analyzer 110. For example, linear algebra may be used to determine a best fit of m, b, and k to the acquired data set. Determination of p(x) may be left to the second step of processing. If the system were perfectly linear, then all points on a three-dimensional plot of tip position vs. velocity vs. acceleration should lie on a single plane. Matrix operations may be used to determine the plane. Rearrangement of equation (1) and re-expression into matrix form yields:

CD=X (2)

where C is a (3×1) matrix of fitting coefficients [m b/m k/m], and D is a (1×n) vector of acceleration data, and X is a (3×n) matrix of containing vectors [h, dx, x]. Solving equation (2) for C=X\D using QR-decomposition (or a similar method) results in the linear fitting coefficients. A rapid and direct extraction of these dynamic parameters may improve scanning probe microscopy even without the further extraction of non-linear components because it may eliminate the use of lock-ins and it may extract all three relevant linear dynamic properties simultaneously. Information of the deviation of the measured response from the assumed linear equation can be further explored and extracted for particular aspects of the non-linearities.

Extraction of p(x) can be accomplished by rearranging equation (1):

p(x(t))·x(t)=h(t)−m·\ddot{x}(t)−b·\dot{x}(t)−k·x(t) (3)

Plotting p(x) vs. x may reveal a force-distance curve. Binning of p as a function of x yields an integrable (over x) data set from which the shape of the local potential well may be determined. This method may be applicable to single frequency excitation if the excitation signal is close to the resonance frequency. Alternatively, this method may be used directly with multifrequncy techniques such as dual-frequency resonant tracking (“DFRT”) and band excitation if the band bounds the resonance.

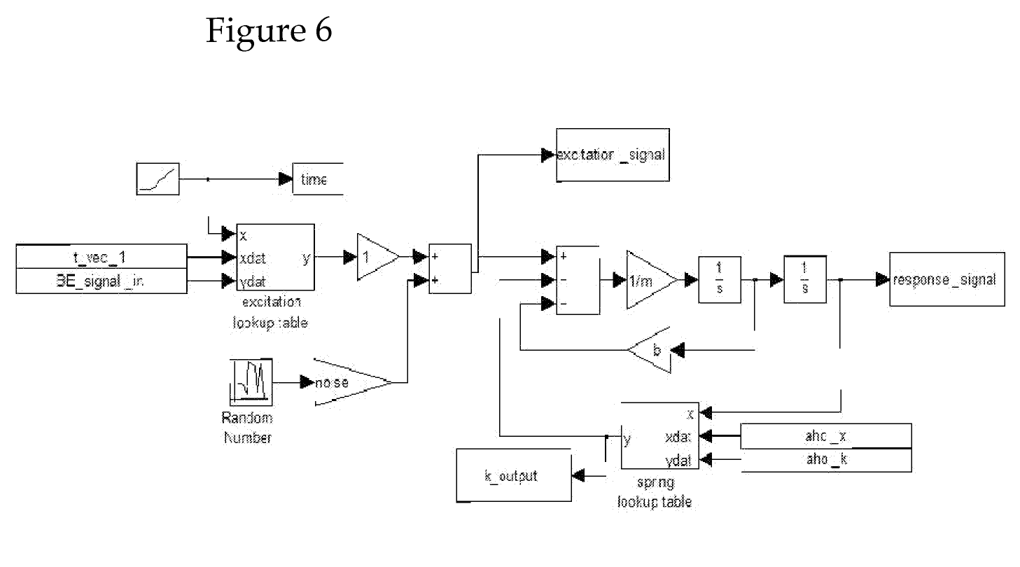

FIG. 6 illustrates a computer simulation of the equation of motion. In particular, FIG. 6 illustrates a Simulink model for simulating the equation of motion from equation (1) for an arbitrary excitation and an arbitrary non-linear spring. The excitation wave (BE_signal_in) as a function of time may be loaded into the excitation look-up table. The function describing spring stiffness (aho_k) as a function of displacement (aho_x) may be loaded into the spring look-up table. Integration (1/s) may be performed in discrete steps. The mass m, and damping coefficient, b, may be constants in this model. The output of the model may give the displacement of the mass as a function of time under the action of a driving force restrained by a damper and a non-linear spring.

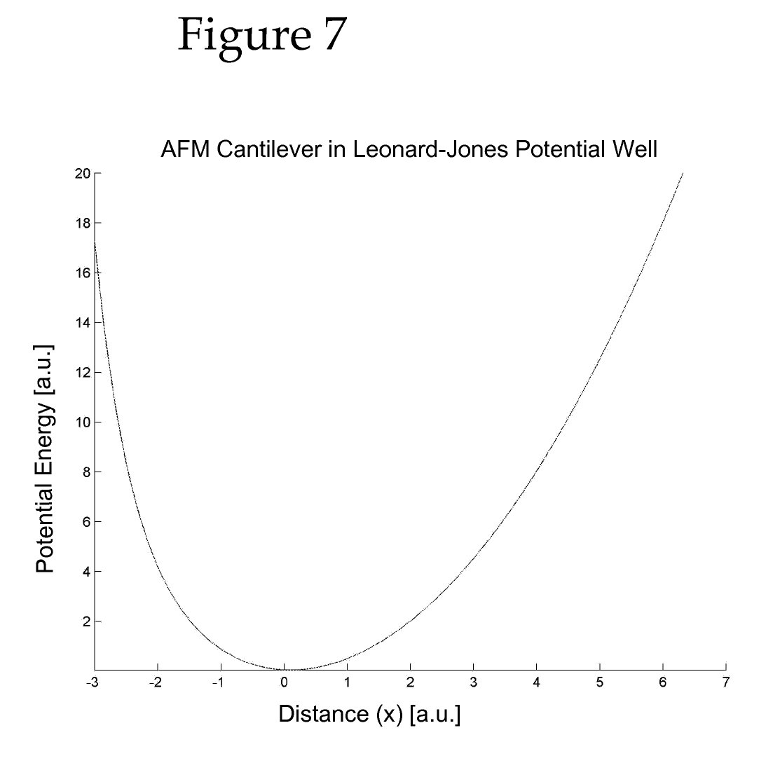

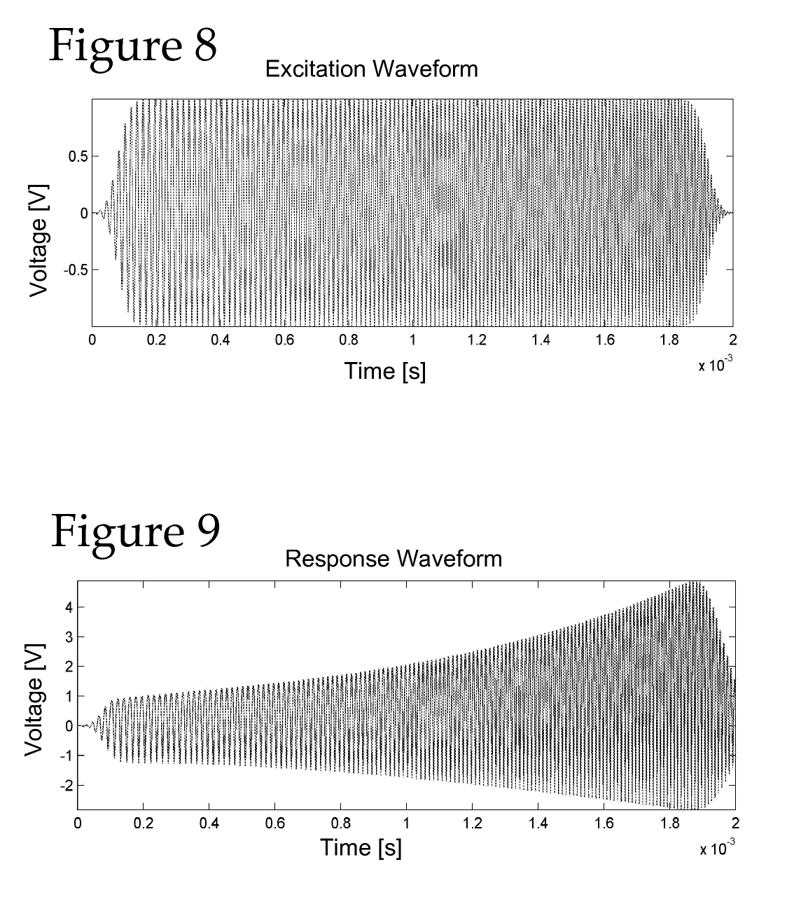

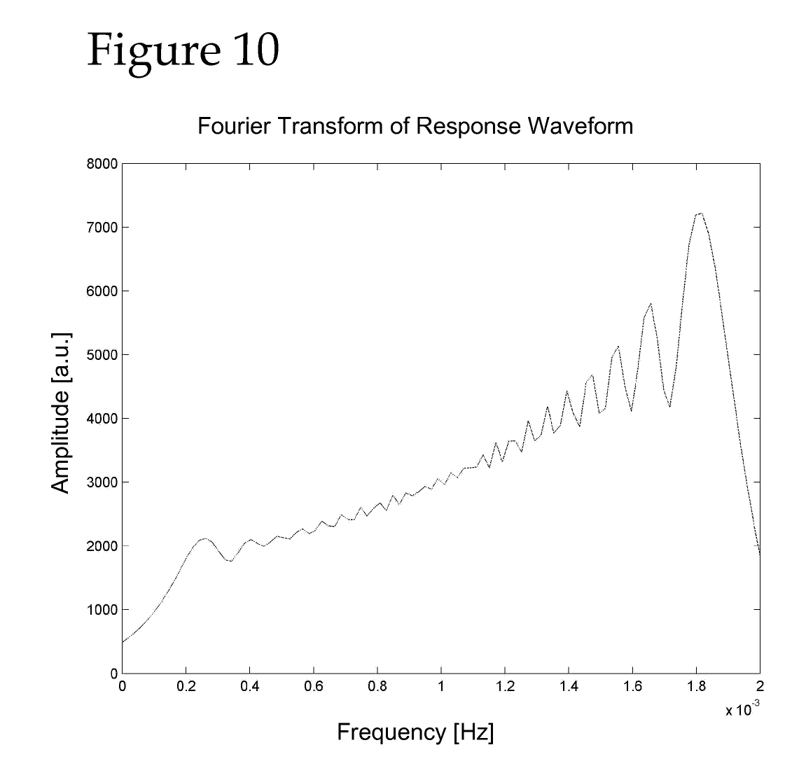

The method for extracting non-linear data by the NIIS analyzer 110 may be referred to a NIIS model. The modeled response of a cantilever (assumed to be a simple harmonic oscillator) in close proximity to a Leonard-Jones potential is shown in FIG. 7. The excitation waveform used in the model is illustrated in FIG. 8 and the highly non-linear response is shown in FIG. 9. In particular, FIG. 8 is a plot of the excitation (chirp function) and FIG. 9 is a plot of the response waveform as a function of time. FIG. 10 is a Fourier transform of the response over the band of excitation frequencies. The highly irregular shape of the response may make extraction of the dynamic parameters difficult.

An analysis of the response using the method described above with respect to FIG. 5 for the NIIS model may improve potential of operating in Fourier space and may extract dynamic parameters directly through manipulations in the time domain.

Three dimensional plots of x(t) vs. \dot{x}(t) vs. \ddot{x}(t) for linear and non-linear springs may illustrate the best fit plane from which the linear parameters may be derived. For the linear case, all data points within the plot lie in a plane and it is possible to directly extract all of the dynamic parameters (mass, damping, and spring constant) directly from the plane fit. However, in the case of a non-linear oscillation, the best fit plane gives the mass, damping, and the linear component of the spring constant. In addition, deviations from linearity are captured as well. Further processing may extract these non-linearities to reconstruct the anharmonic potential well.

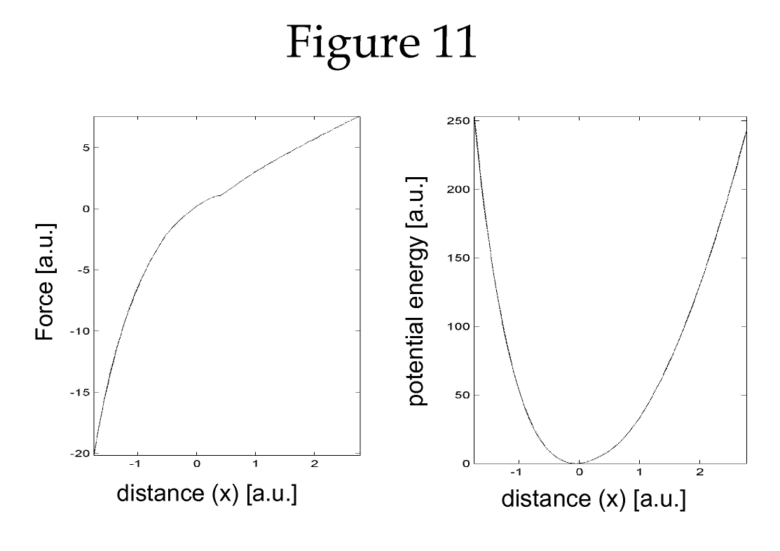

With the linear components of dynamic response determined, the non-linearities of the spring (potential well) may be extracted using equation (3) discussed above. The results of binning and the derived force-distance curve for the case of a Leonard-Jones potential is illustrated in FIG. 11. The curve is integrated to determine the shape of the potential well as shown in the potential energy plot. In particular, FIG. 11 illustrates a plot of (k+p(x(t))) vs. x(t) as determined from equation (3) averaged over many oscillations. Integrating over force vs. distance as a function of distance yields the shape of the potential well for the potential energy plot.

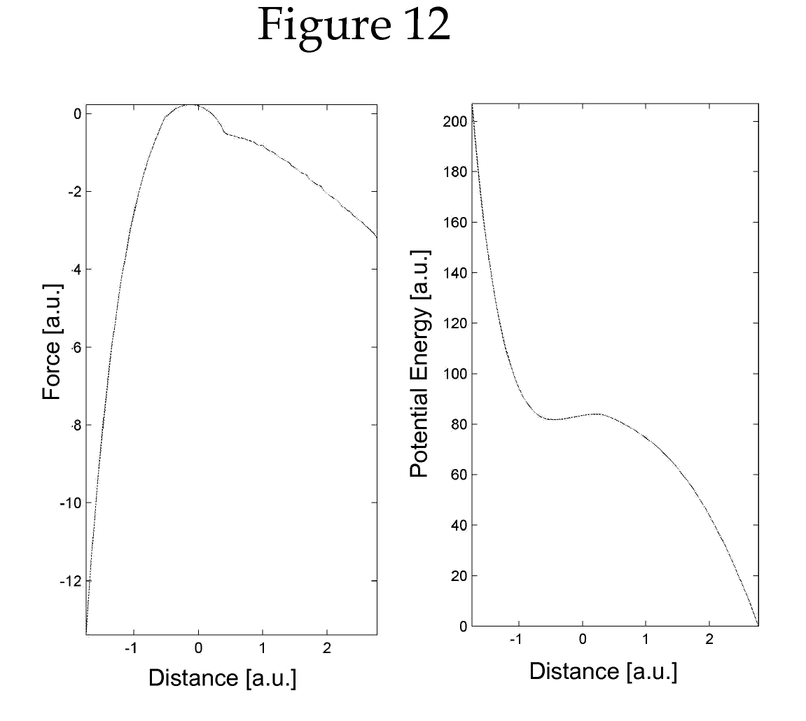

FIG. 12 illustrates the non-linear component of the of the measured force-distance curve, p(x(t)) vs. x(t), and the non-harmonic component of the potential well. In FIG. 12, the non-harmonic component of the potential well is illustrated in the potential energy plot.

The NIIS analysis model may be assisted and/or used in parallel with lock-in and phase-locked loops so that the linear data is captured by these common methods, while the potential well mapping is performed using NIIS. The model may be applicable to nearly any differential equation. For instance it may be possible to extend this to coupled ordinary differential equations or even to the Euler-Bernoulli beam (partial differential equation with arbitrary weight and force distribution) to model the cantilever and its higher modes and mode interactions. The approach may give the control and acquisition a much better understanding of the system it is controlling.

Non-linear interaction imaging and spectroscopy (NIIS) for scanning probe microscopy is a fast technique for retrieving both the linear and non-linear components of the interactions between the probe tip and the surface. The analysis enables an extraction of local potential energy vs. distance curves (potential wells) over an array of points across the surface. Within the non-linear interactions may be relevant information about the surface, which may otherwise be missed. For example, the local chemical identity of the surface may have a strong influence on the tip-trajectory in the region of closest approach between the tip and the surface. NIIS may be capable of extracting this non-linearity and reconstructing the local potential energy profile thus enabling the differentiation of chemical species on the nanoscale.

Reconstruction of the potential wells may also lends insight into other short-range interactions such as nano-indentation for yielding information about elastic and visco-elastic properties as well as long-range tip-surface interactions related to electric and magnetic fields. Furthermore, the information gathered using NIIS may be used as feedback signals, thus allowing the microscope to seek-out and track particular optimal operating conditions for the extraction of relevant information.

The system and process described may be encoded in a signal bearing medium, a computer readable medium such as a memory, programmed within a device such as one or more integrated circuits, and one or more processors or processed by a controller or a computer. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

We claim:

1. A method of vibration analysis comprising:
receiving a signal for position and time of a vibrating source;
applying an equation of motion to the received signal;
analyzing the equation of motion to identify variables from the equation of motion that are measured;
establishing a fit of the identified of variables to the received signal; and
extracting non-linear components of the signal using the fit.

2. The method of claim 1 wherein the source of vibration comprises an oscillator.

3. The method of claim 1 wherein the source of vibration comprises a cantilever for scanning probe microscopy.

4. The method of claim 1 wherein the extracting non-linear components further comprises:
determining a plane from the fit of the identified variables; and
extracting the non-linear components from the plane.

5. The method of claim 1 wherein the vibration comprises an oscillating tip on a cantilever and the non-linear components comprises a spring stiffness for the cantilever, wherein the fit comprises a determination of the spring stiffness.

6. The method of claim 1 wherein the equation of motion is m·\ddot{x}(t)+b·\dot{x}(t)+[k+p(x(t))]·x=h(t), where is x is position, m is mass, b is damping, k is linear spring stiffness, p(x(t)) is a nonlinear component of spring stiffness, and h is the excitation signal.

7. The method of claim 6 wherein the identified variables comprise the position x, the damping b, and the linear spring stiffness k.

8. The method of claim 6 wherein the non-linear components comprises p(x(t)).

9. The method of claim 8 wherein the fit comprises a determination of p(x(t)).

10. The method of claim 1 wherein the analyzing further comprises:
selecting the equation of motion for the vibrating source; and
measuring the identified variables from the equation of motion.

11. In a non-transitory computer readable medium having stored therein data representing instructions executable by a programmed processor for analysis of non-linear interaction data from a scanning probe microscope, the storage medium comprising instructions operative for:
receiving data from measurements by the scanning probe microscope, wherein the measurements by the scanning probe microscope comprise non-linear interactions;
utilizing the data within an equation of motion;
analyzing the data to identify the non-linear interactions from the data within the equation of motion; and
extracting the identified non-linear interaction from data based on the analysis of the data within the equation of motion.

12. The computer readable medium of claim 11, wherein the scanning probe microscope comprises an atomic force microscope.

13. The computer readable medium of claim 11, wherein the measurements by the scanning probe microscope comprises imaging data of a surface based on an interaction of a probe from the scanning probe microscope with the surface.

14. The computer readable medium of claim 11, wherein the equation of motion is m·\ddot{x}(t)+b·\dot{x}(t)+[k+p(x(t))]·x=h(t), where is x is position, m is mass, b is damping, k is linear spring stiffness, p(x(t)) is a nonlinear component of spring stiffness, and h is the excitation signal.

15. The computer readable medium of claim 14, wherein the non-linear interactions comprise p(x(t)).

16. The computer readable medium of claim 14, wherein the analysis comprises establishing a fit of the position x, the damping b, and the linear spring stiffness k, wherein each of position x, the damping b, and the linear spring stiffness k are measured and the received data is fit to the measurements.

17. A system for non-linear interaction imaging comprising:
a measurement device for interacting with a surface to be measured;
a detector coupled with the measurement device that detects raw data regarding the interaction with the surface, wherein the interaction comprises a vibration that is measured; and
a non-linear interaction analyzer coupled with the detector that receives the raw data and utilizes an equation of motion for the vibration to extract non-linear components of the interaction.

18. The system of claim 17 wherein the measurement device comprises a cantilever and the vibration is caused by an oscillating tip of the cantilever interacting with the surface.

19. The system of claim 17 wherein the measurement device comprises a scanning probe microscope and the raw data comprises imaging data from the scanning probe microscope, wherein the interaction is between an oscillating probe of the scanning probe microscope and the surface being measured

20. The system of claim 17 wherein the extraction of non-linear components comprises identifying variables of the equation of motion that are known based on measurement and determining a best fit for those variables, wherein the non-linear components are extracted from the best fit.
